(19) United States
(12) Patent Application Publication
(10) Pub. No.: US 2007/0185658 A1
(43) Pub. Date: Aug. 9, 2007

(54) Determining probabilities of inherited and correlated traits

(76) Inventors: Steven Mark Paris, Watertown, MA (US); Tamela Louise Jamieson, Andover, MA (US)

Correspondence Address: HOLLAND & KNIGHT LLP, 10 ST. JAMES AVENUE, 11th Floor, BOSTON, MA, 02116-3889, US

(21) Appl. No.: 11/348,433

(22) Filed: Feb. 6, 2006

(51) Int. Cl. G06F 19/00

(52) U.S. Cl. 702/20

(57) ABSTRACT

Methods and apparatus, including computer program products, for determining probabilities of inherited and correlated traits. A computer-implemented method includes calculating a probability of an initial trait being present in an individual by examining a presence or absence of the trait in genetically-related family members.

### BACKGROUND

The present invention relates to inheritable traits, and more particularly to determining probabilities of inherited and correlated traits.

In biology, a trait or character is a genetically inherited feature of an organism. A trait may be any single feature or quantifiable measurement of an organism. However, the most useful traits for genetic analysis are present in different forms in different individuals.

The inheritance of acquired characters (or characteristics) is the hereditary mechanism by which changes in physiology acquired over the life of an organism are transmitted to offspring.

### SUMMARY

The present invention provides methods and apparatus for determining probabilities of inherited and correlated traits.

In one aspect, the invention features a computer-implemented method including calculating a probability of an initial trait being present in an individual by examining a presence or absence of the trait in genetically-related family members.

In embodiments, the method can include correlating the probability of one or more traits after having found the probability of the initial trait.

The probability, a dispersal and a drift can be displayed in a numerical or symbolic representation associated with a body diagram. The probability, a dispersal and a drift can be displayed in tabular, report, notebook or other written formats.

The invention can be implemented to realize one or more of the following advantages.

Using the present invention, individuals can benefit from knowing the probabilities of various traits given the presence or absence of the traits in other family members. Such traits might include hemophilia, breast cancer, heart disease and leukemia.

Various animal racing and breeding industries have carefully established genealogies. It is advantageous to these industries to be able to calculate the probabilities of traits being expressed in a particular individual using the present invention.

The present invention enables determining the probability of one or more traits in an individual based on the medical history of gene-related family members.

The present invention enables one or more indications, such as whether the trait or traits were more prevalent in past generations or have become more prevalent in later generations.

The present invention calculates the probability of related traits being expressed in an individual given the occurrence of another trait.

The present invention enables calculation of trait probabilities. Methods include traversing a genealogical tree of arbitrary depth and width, summing occurrences of trait[s] in family members, determining the genetic “skewness” of a trait that occurs across relations, determining the genetic “drift” of a trait that occurs across generations, and determining trait correlations.

Methods include interpreting and displaying results, including, for example, report, tabular and graphical representations of the probability results.

The method enables measurement of the possibility of traits occurring in one individual given the presence or absence of the same traits in genetically-related family members. The method provides additional values to determine where in a family tree the trait occurs and methods to display the results of the investigation. In total, calculations, methods and presentations provide a powerful way to track the progression of traits in genetically-related families.

One implementation of the invention provides all of the above advantages.

Other features and advantages of the invention are apparent from the following description, and from the claims.

### BRIEF DESCRIPTION OF THE DRAWINGS

FIG. 1 is an exemplary family tree.

FIG. 2 is an exemplary tree represented in mathematical format.

FIG. 3 illustrates how an individual with two parents inherits a trait.

FIG. 4 illustrates mathematics underlying probability calculations.

FIGS. 5A-5F are flow diagrams of the probability calculations.

FIG. 6 is a block diagram.

FIG. 7 is a body system diagram.

FIG. 8 is an illustration.

FIG. 9 is a report.

### DETAILED DESCRIPTION

The following terms are helpful when reading the detailed description.

A “node” refers to a single individual.

A “child(ren)” refers to descendant(s) of a node.

“Parents” refer to the antecedents (ancestors) of a node. Every node has two parents.

“Siblings” refer to nodes that descend from the same parent node.

A “tree” refers to a collection of nodes with lines indicating successors and predecessors.

A “sub-tree” refers to a subset of the family tree.

A “trait” refers to a condition, characteristic, property or distinguishing feature of a node.

“Grand” refers to a node two generations removed from a given node.

“Great-grand” refers to a node three generations removed from a given node.

“Self” refers to an individual node under examination that has parents and possibly siblings and children.

“Higher (or earlier)” refers to predecessor node(s).

“Lower (or later)” refers to successor node(s).

“Expressed” refers to an indication that a trait's effects are visible in an individual.

“Skewness” refers to a mathematical value indicating how a curve leans.

“Dispersal” refers to a measurement of the prevalence of a trait on one side of a tree or another.

“Drift” refers to a measurement of the prevalence of a trait in earlier or later generations of a tree.

“Inheritance” refers to a trait that is more likely to be found in a node if earlier nodes also possess the trait.

“Transmissibility” refers to a likelihood that a parent's trait is present in a child as well.

“Augmentation” refers to a likelihood that as more and more nodes in a tree possess a trait, that other nodes will, too.

“Correlation” refers to a likelihood that individual traits cause other traits to occur as well.

“Integration” refers to a process of observing how many relatives of a node have a particular trait and using those observations to calculate the probability that the node has the trait as well.

“Incidence” refers to a number of new cases of a given disease during a given period in a specified population. It also is used for the rate at which new events occur in a defined population. It is differentiated from prevalence, which refers to all cases, new or old, in the population at a given time.

“Prevalence” refers to a total number of cases of a given disease in a specified population at a designated time. It is differentiated from incidence, which refers to the number of new cases in the population at a given time.

“Penetrance” refers to a probability of a gene or genetic trait being expressed. “Complete” penetrance means the gene or genes for a trait are expressed in all the population who have the genes. “Incomplete” penetrance means the genetic trait is expressed in only part of the population. The percent penetrance also may change with the age range of the population.

“Mortality” is the number of deaths from a particular disorder occurring in a specified group per year. Mortality is usually expressed as a total number of deaths.

“Lifetime Risk” is the average risk of developing a particular disorder at some point during a lifetime. Lifetime risk is often written as a percentage or as “1 in (a number).” It is important to remember that the risk per year or per decade is much lower than the lifetime risk. In addition, other factors may increase or decrease a person's risk as compared with the average.

“Hardy-Weinberg” refers to a mathematical equation describing an ideal genotype population distribution, assuming known gene frequencies and five conditions all being met (no mutations, infinitely large population, random mating, no migration and no genetic drift). The Hardy-Weinberg principle states that, under certain conditions, after one generation of random mating, the genotype frequencies at a single locus will become fixed at a particular equilibrium value.

The present invention summarizes the probability of a trait being inherited by one member of a family of related individuals. The probability is ultimately presented as a single number with a value between 0.0 and 1.0. A value of 0.0 means there is no evidence of the trait existing in either the individual or a family member and 1.0 means there is absolute certainty of the trait existing in the individual.

The present invention examines every accessible, genetically-related member of the individual's family. Starting with a probability value of 0.0, the present invention adds a weighted value to the probability if a family member possesses the trait. The weighted values decrease with each previous generation as well as “distance” from an individual. That is, the presence of a trait in a great-grandparent is weighted less than the presence of a trait in a parent. Likewise, the presence of a trait is weighted more in a first cousin than in a fourth cousin.

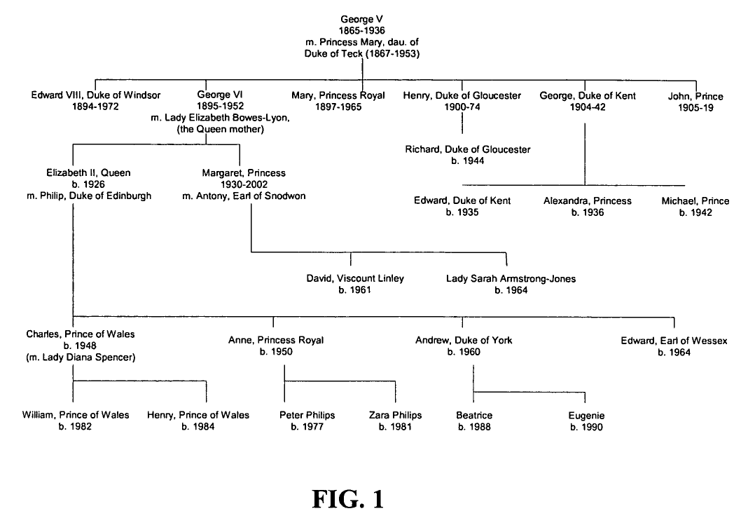

Referring to FIG. 1, a representative family tree 10 illustrates several features. For example, every individual is genetically related to two parents. An individual may have one surrogate parent. A family member may have zero or more descendants. Adoptive parents or adoptive offspring are not genetically related and do not appear in the family tree. In this particular example, the tree 10 is a partial diagram of the British royal family from the time of George V. Divorces and re-marriages have been omitted, as they have no genetic effect on offspring. Note that the number of descendants ranges from zero in the case of Prince John at the upper right of the tree 10, to six for George V at the top of the tree 10.

Consider Andrew, Duke of York towards the bottom of the tree 10. Andrew's children are Beatrice and Eugenie. His parents are Elizabeth and Philip. Elizabeth's parents were George VI and Elizabeth and George's parents were George V and Mary. Andrew would be most interested in traits inherited from the above-mentioned individuals (and individuals similarly related to his father); less interested in traits appearing in his children and siblings and much less interested in traits appearing in more distant relatives such as Michael (appearing on the right of the tree 10).

Our process begins with the individual being examined. If that individual actually has the trait in question, our process reports that the probability of the trait being present is 1.0, or 100%. However, our process continues examining individuals in the family tree in order to calculate drift, skewness and trait correlations.

If the individual does not exhibit or express the trait, it may be dormant or the individual may not yet be old enough to express the trait or the individual might never express the trait. Our process sets the probability to zero and begins examining all ancestor relatives in the family tree. Our process uses a recursive method to increment the probability values as it examines each family member for the trait.

Although family trees are generally shown as branching “upwards”, the usual representation of such trees is to show a tree branching “downwards.” Adopting the latter convention, our process can be said to perform a “preorder” traversal of a family tree.

Tree traversal is the process of visiting each node in a tree data structure. In a preorder traversal, each node is visited before any of its children.

More specifically, a preorder traversal is defined recursively as follows. To do a preorder traversal of a general tree: visit the root node first; then do a preorder traversal each of the sub-trees of the root one-by-one in the order given.

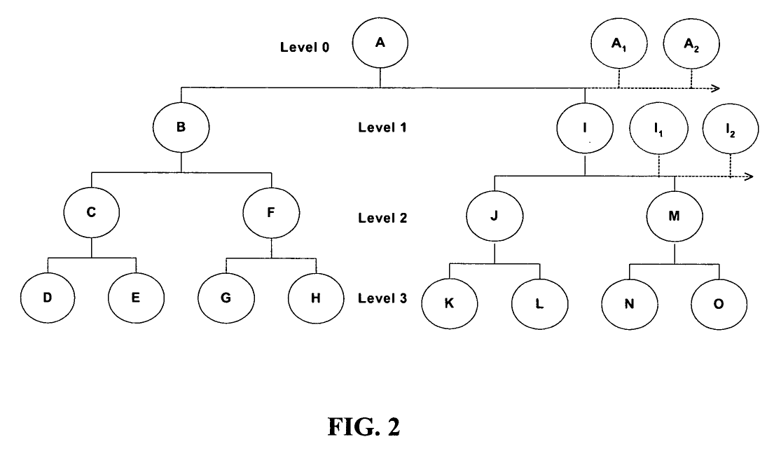

FIG. 2 is an exemplary mathematical representation of a family tree 20. Note that the tree 20 is inverted so that the latest descendant is at the top. Note the perfect symmetry downward since each offspring was the result of a union between two parents. However, note that at each generation the possibility arises of more than one offspring. These siblings become cousins in later generations and their contribution to the trait probability sum falls off quickly.

A preorder traversal of the tree 20 visits the nodes in the order A, B, C, D, E, F, G, H, I, J, K, L, M, N, O. The traversal is called “preorder” because the root is visited first. In the special case of a binary tree: visit the root first; and then traverse the left subtree; and then traverse the right subtree.

Family trees are special cases of binary trees. Every individual, whether fish, fowl, reptile or man, has exactly two genetically related parents. Parents can have more than one offspring, however. Individuals do not inherit traits from siblings, aunts, uncles and cousins. But the presence of a trait in such relatives might be an indication that the trait also exists or will eventually express itself in the individual as well.

Therefore, our process examines these “indirect” relatives to determine if there is a predisposition to the trait in the family. These indirect relatives necessarily contribute smaller amounts to a probability calculation. Some indirect relatives are labeled in the sample tree as A₁, A₂, I₁, I₂. If a direct ancestor contributes 1/Z to the probability sum, an aunt or uncle contributes 1/aZ to the probability sum if they also exhibit the trait, where “a” is a “distance” factor. The descendants of aunts and uncles each contribute 1/aZ^{x} to the probability sum, where x increases for each successor generation and “Z”, representing the base of the exponential expression Z^{X}, represents the “decay factor.”

Our process takes into consideration the question of surrogates. Although a surrogate might not contribute genetic material to the individual, a surrogate might, nonetheless, cause the individual to be born with birth defects such as blood diseases, deformities, and so forth. Surrogates, therefore, arbitrarily contribute a value 1/a times the contribution of a genetic ancestor if the surrogate exhibits the trait. Alternatively, research might show that if no genetically-related individuals express a trait and the individual of interest possesses the trait, then the surrogate may have been the contributor to that trait. An example would be offspring born with a deformity or condition related to a drug taken during pregnancy.

An effect of these calculations is that additions to the probability value decrease with each preceding generation and also decrease with “distance” from the individual. For example, if a fifth cousin expresses a trait, the fact that the cousin exhibits the trait contributes only a very small amount to the probability sum, considerably less than if a grandfather exhibits the same trait. Contributions to the probability sum decrease according to a “decay” value which is the base value of the exponential expression.

Our process takes into consideration the question of descendants. It is possible that the expression of a trait in descendants is an indication that the individual may be a carrier of the trait or that the individual has not yet expressed the trait. For example, a mother whose two daughters both develop breast cancer might wish to consider screening for the disease as well. This is not “Lamarckianism,” but, rather, a truthful investigation into the prevalence of a trait in a family. Lamarckism was a theory of biological evolution proposed by French biologist Jean-Baptiste Pierre Antoine de Monet, Chevalier de Lamarck, since disproven. Developed in the early 19th century, Lamarckism held that traits acquired (or diminished) during the lifetime of an organism can be passed on to the offspring.

We note that all family members must be considered and the presence or absence of traits contributes to the final calculation. In the case of descendants, contributions are computed as 1/Y^{x} where Y is the base of the exponential expression and X increases for each succeeding generation. As an example, a value of 2 for Y and 1 for X, would produce a value of ½ for a descendant. Suitable values must be chosen for Y and X to “weight” descendants appropriately.

The question of half-siblings is answered simply: since the sibling shares only one parent, the contribution to the probability value is simply ½ the contribution of a full sibling who shares both parents.

Dispersal is calculated the same way as the probability value except that if the trait is discovered on the father's side, the contributory value is first multiplied by −1 and then added to the sum. Thus, a value less than 0.0 (i.e., negative) indicates that the trait appears primarily or only on the father's side; a positive value indicates that the trait appears primarily or only on the mother's side. A value of zero indicates one of three things: the trait does not appear in any family member; or the trait appears equally as often on the mother's side as on the father's side; or the trait appears only in the individual of interest.

Drift is calculated only for family members directly in the line of inheritance (i.e., parents, grandparents, great-grandparents, and so forth). The drift is initialized to 0.0. For each preceding generation X, if any family member is found in that generation to possess the trait, a value of 110 is added to the sum. As an example, the sum could become a number like 100111, indicating that the trait was more prevalent closer to the current generation than it was further back in the family tree.

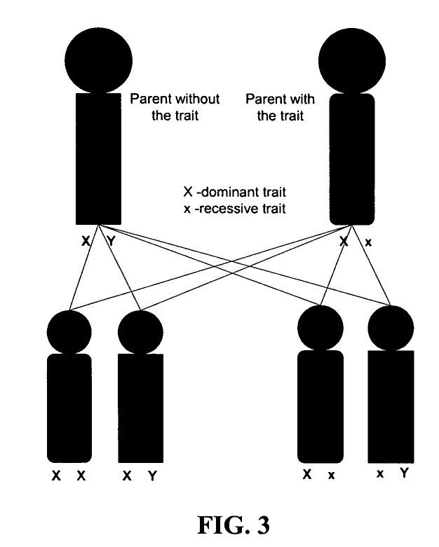

FIG. 3 is an exemplary genetic diagram 100 illustrating trait inheritance. The fact that children can inherit in the manner shown, does not mean that children will inherit specific traits. Therefore, our process makes no specific predictions about an individual expressing a trait. Rather, the probability figure derived from examining relatives' traits should be taken as a general prediction of the likelihood of the trait being present in an individual. Note also that the figure marked “X X” at bottom left has inherited the dominant trait. This does not necessarily mean that the individual expresses the trait or expresses it at an early age. However, by looking at the diagram 100, it is possible to say that there is some possibility of the individual having acquired the trait. In fact, one could state the same conclusion about all four child nodes. No one would necessarily know which, if any of the children inherit the trait. It is possible that none may have the trait or all may have it.

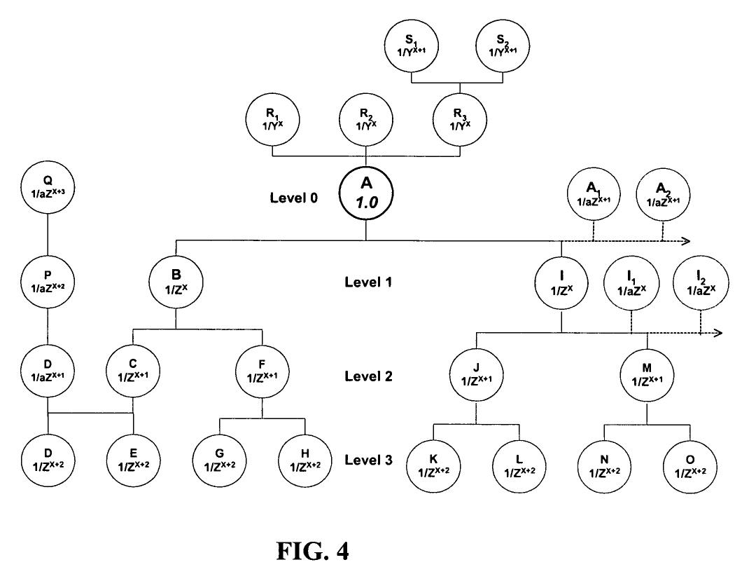

As shown in FIG. 4, values of various relations in the family tree are diagrammed. The individual (at level 0) is assigned a value of 1.0. If the individual expresses the trait, then the probability is exactly 1.0, or 100%. Direct ancestors contribute a value that is a factor of 1/Z. Indirect relations are calculated similarly, but there is a further factor of 1/a applied. Siblings at any generation have the same probability as the direct ancestor with the 1/a factor applied. Descendants (R₁, R₂, S₁, S₂, S₃) are similarly calculated but use a base Y instead of Z (which may be, but do not have to be equal). Surrogates (not noted on the diagram) are given the same value as the genetic parent, multiplied by a factor of 1/aZ. Half siblings are calculated the same way, by multiplying by a factor of 1/aZ.

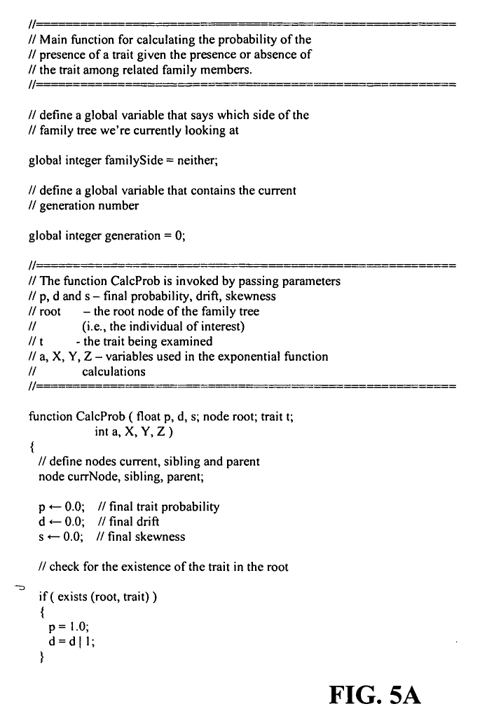

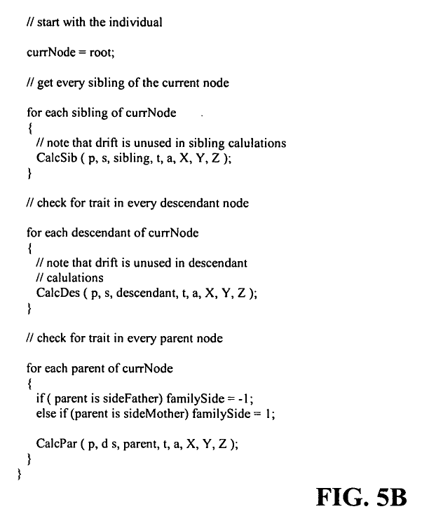

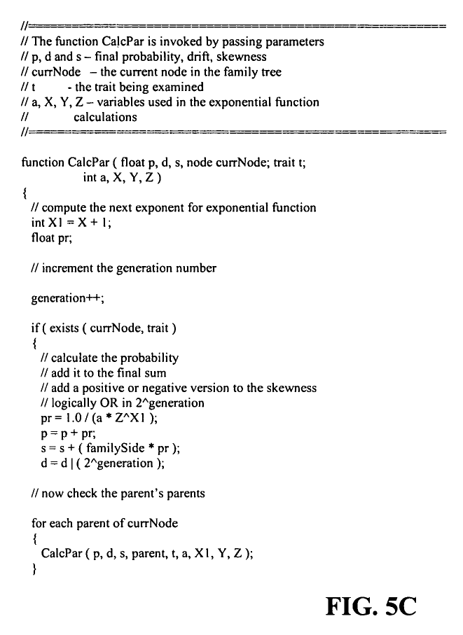

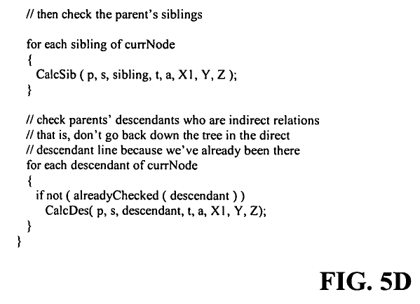

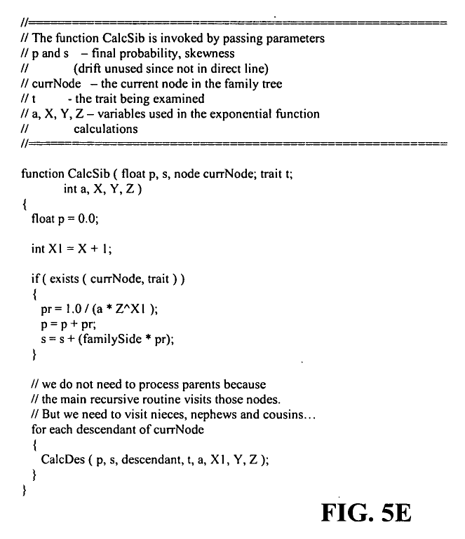

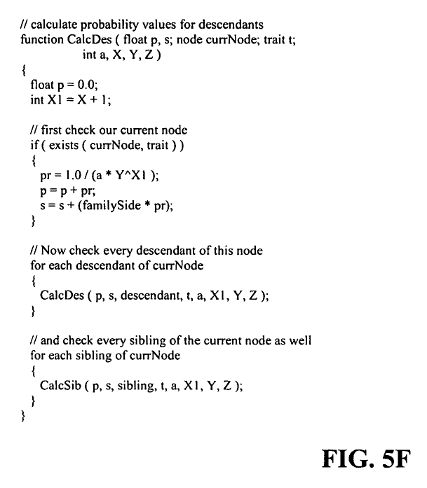

As shown in FIG. 5, process 200 calculates a final probability value. Process 200 is presented in pseudo-code format. The values a, X, Y and Z are user-selectable. Process 200 includes a main function, CalcProb, and a number of worker functions CalcDes, CalcPar, CalcSib.

As an example, if the values chosen are a=4, X=2, Y=4, Z=2, parents would have probability addition values of ¼; grandparents would have values of ⅛; siblings of grandparents would add 1/32, and so forth.

Process 200 includes measures of both the “drift” and “dispersal” of the trait. Drift, or “D”, measures the prevalence of the trait in the direct ancestor chain. Process 200 generates an array of 0 or 1 values representing the presence or absence of the trait in preceding generations. When the tree traversal is complete, process 200 can determine whether occurrences are more common in earlier or later generations. The population sample in most family trees is far too small to calculate a true skewness figure. Therefore, the D factor is only a rough approximation of the trait prevalence.

The dispersal factor, “S”, similarly measures how widespread the trait is among relations across the tree. A high negative value of indicates common occurrence on the father's side of the family tree, while a positive value of indicates occurrences on the mother's side. A value of 0.0 may indicate either no occurrences or a very balanced set of occurrences on both sides of a tree.

Occurrence of one trait frequently correlates with the occurrence of another. Diabetics, for example, see increased risks of heart and eye diseases, neuropathy and other conditions. Once the final probability factor is calculated, it is a simple matter to take that value and multiply it by another value contained in a table that indexes correlations among traits.

The probability, drift, dispersal and correlation values can be displayed in many common formats. Simple textual output is quick and convenient. Bar charts may be used to show high trait probabilities. Spreadsheets can list all traits and probability values. In addition, process 200 supports graphical presentations.

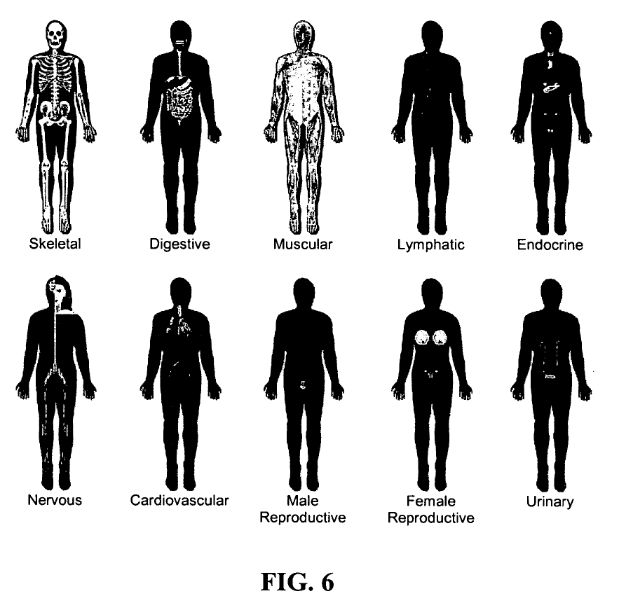

As shown in FIG. 6, a user begins by selecting one of the included views of the human body.

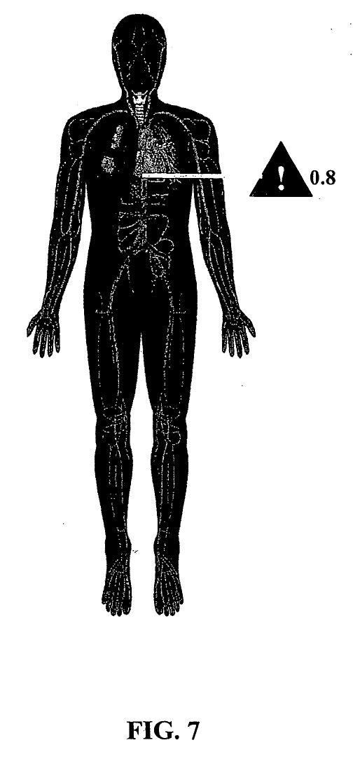

As shown in FIG. 7, a major body system 250 is displayed and indicators are placed next to items of high importance. The triangle, exclamation point and line draw attention to the heart. The 0.8 probability value indicates that there is a high probability of a trait (associated with the heart) being present in the individual's family.

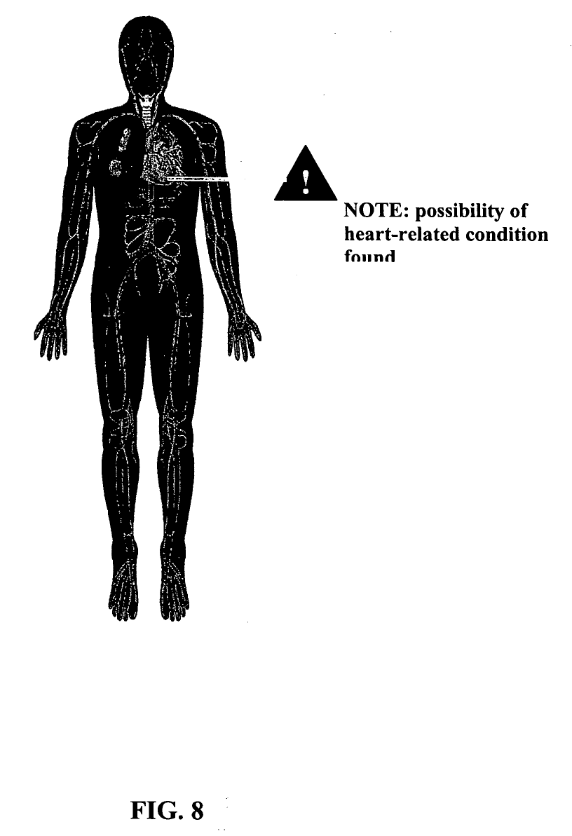

Most individuals would have no idea what a number like “0.8” next to their heart means. Therefore, process 200 can map numeric values to “fuzzy” values to produce an illustration 300 shown in FIG. 8.

In addition to a body system display, process 200 can report its results in tabular and report form. In the tabular form, as shown in the table that follows, a list of traits is displayed along with dispersal and drift results. Correlations to other possible traits are noted as well.

| Trait | Probability | Dispersal | Drift | Correlation[s] |
|---|---|---|---|---|
| Diabetes | 67% | 82% | 01011 | Heart |

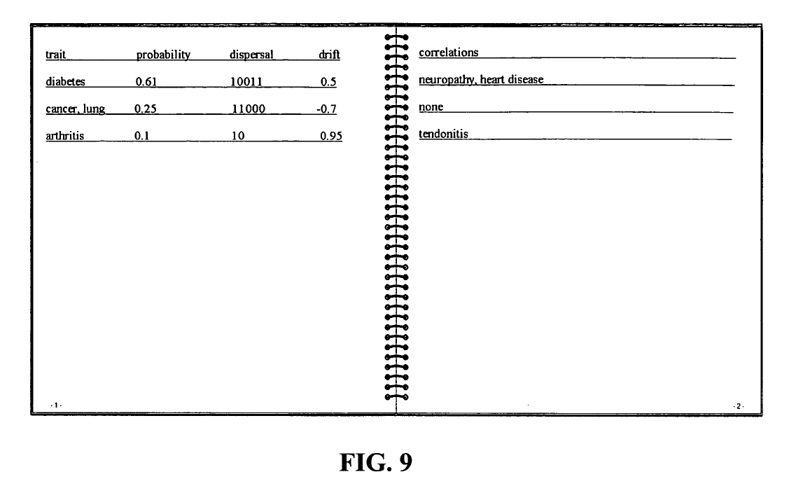

As shown in FIG. 9, a report form 350 summarizes trait occurrences in a format similar to a notebook.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
calculating a probability of an initial trait being present in an individual by examining a presence or absence of the trait in genetically-related family members.

2. The computer-implemented method of claim 1 further comprising calculating a dispersal of a trait among family members by examining a presence or absence of the trait in genetically-related family members.

3. The computer-implemented method of claim 1 further comprising calculating a drift of a trait among family members by examining a presence or absence of the trait in genetically-related family members.

4. The computer-implemented method of claim 1 further comprising correlating the probability of one or more traits after having found the probability of the initial trait.

5. The computer-implemented method of claims 1 wherein the probability, a dispersal and a drift are displayed in a numerical or symbolic representation associated with a body diagram.

6. The computer-implemented method of claim 1 wherein the probability, a dispersal and a drift are displayed in tabular, report, notebook or other written formats.

7. A computer program product, tangibly embodied in an information carrier, the computer program product being operable to cause data processing apparatus to:
calculate a probability of an initial trait being present in an individual by examining a presence or absence of the trait in genetically-related family members.

8. The computer program product of claim 7 further operable to cause data processing apparatus to:
correlate the probability of one or more traits after having found the probability of the initial trait.

9. The computer program product of claim 7 wherein the probability, a dispersal and a drift are displayed in a numerical or symbolic representation associated with a body diagram.

10. The computer program product of claim 7 wherein the probability, a dispersal and a drift are displayed in tabular, report, notebook or other written formats.

11. A computer system comprising:
a display device;
a central processing unit; and
a memory, the memory comprising:
means for calculating a probability of an initial trait being present in an individual by examining a presence or absence of the trait in genetically-related family members.

12. The computer system of claim 11 wherein the memory further comprises means for correlating the probability of one or more traits after having found the probability of the initial trait.

13. The computer system of claim 11 wherein the probability, a dispersal and a drift are displayed in a numerical or symbolic representation associated with a body diagram.

14. The computer system of claim 11 wherein the probability, a dispersal and a drift are displayed in tabular, report, notebook or other written formats.
